(19) United States
(12) Patent Application Publication
(10) Pub. No.: US 2009/0068304 A1
(43) Pub. Date: Mar. 12, 2009

(54) Device for making a rubber stamp by oneself

(76) Inventor: Chien Liang Lin, Jhonghe City (TW)

Correspondence Address: PRO-TECHTOR INTERNATIONAL SERVICES, 20775 NORADA CT., SARATOGA, CA, 95070, US

(21) Appl. No.: 11/899,822

(22) Filed: Sep. 7, 2007

(51) Int. Cl. B28B 1/48

(52) U.S. Cl. 425/458

(57) ABSTRACT

A device for making a rubber stamp by oneself is composed of a graving tool which is emplaced flat on a soap bar, with a pointed cone which is protruded downward at an end of the graving tool being inserted into the soap bar for engraving into notches of texts or a pattern in equal depth, according to one's preference. Next, flexible polymer clap is rubbed and squeezed and is then pressed on the notches of the soap bar, to copy into a block of flexible polymer clay having a protruded pattern. Finally, the flexible polymer clap is put into Ian oven for baking and curing, and is then attached on a block object in a cubical shape by a double-sided adhesive tape, so as to form a self-created rubber stamp.

### BACKGROUND OF THE INVENTION

a) Field of the Invention

The present invention relates to a device for making a rubber stamp, and more particularly to a graving tool which can be used to engrave into preferred texts and patterns, and then to make a rubber stamp with flexible polymer clay, by oneself.

b) Description of the Prior Art

As an conventional ordinary stamp is made on a large machine and formed by opening a mold and hot press by a vendor, a consumer is not able to make a rubber stamp by himself or herself with DIY (Do-It-Yourself), and needs to purchase many stamps to change different patterns.

### SUMMARY OF THE INVENTION

Accordingly, the primary object of the present invention is to provide a device for making a rubber stamp by oneself, wherein on a smooth surface of a bar of soap is engraved into a pattern with a special graving tool, and then the pattern is copied with flexible polymer clay which is next cured through baking with an oven, thereby creating a rubber stamp of preferred texts and patterns.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a perspective view of a graving tool of the present invention.

FIG. 2 shows a side view of a graving tool of the present invention.

FIG. 3 shows a schematic view of a graving tool which is emplaced flat on a bar of soap for engraving, according to the present invention.

FIG. 4 shows a schematic view of flexible polymer clap which is rubbed and squeezed into a block in an irregular-shape, and emplaced on a bar of soap, according to the present invention.

FIG. 5 shows a schematic view of flexible polymer clay which is pressed on a bar of soap by fingers, according to the present invention.

FIG. 6 shows a schematic view of flexible polymer clap which is copied with a protruded pattern, and is emplaced in an oven for baking, according to the present invention.

FIG. 7 shows a schematic view of baked flexible polymer clay which is cured into a rubber stamp, and is then attached on an object, according to the present invention.

### DETAILED DESCRIPTION OF THE PREFERRED EMBODIMENTS

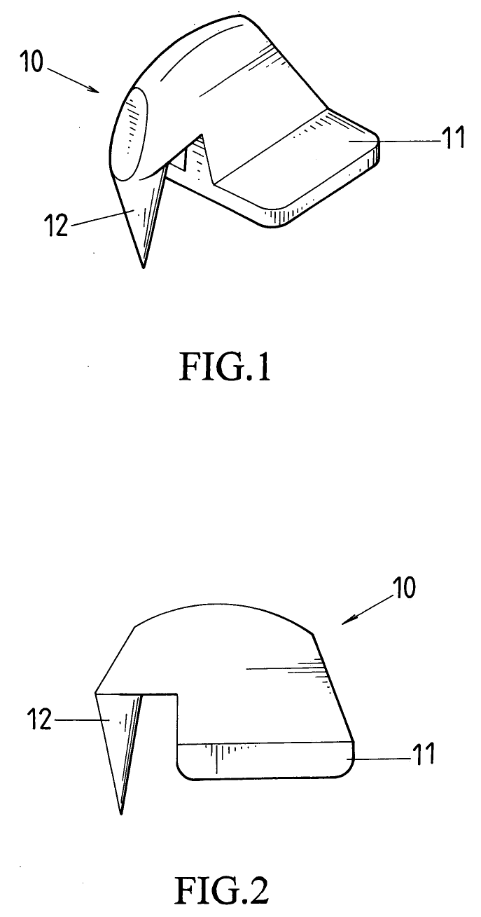

Referring to FIG. 1 and FIG. 2, a graving tool 10 of the present invention is a product made by plastic extrusion, and is provided with a horizontal seat 11 and a pointed cone 12 which is located at the other end of the horizontal seat 11 and is protruded downward vertically to exceed a bottom surface of the horizontal seat 11.

A DIY manufacturing process of the present invention includes:

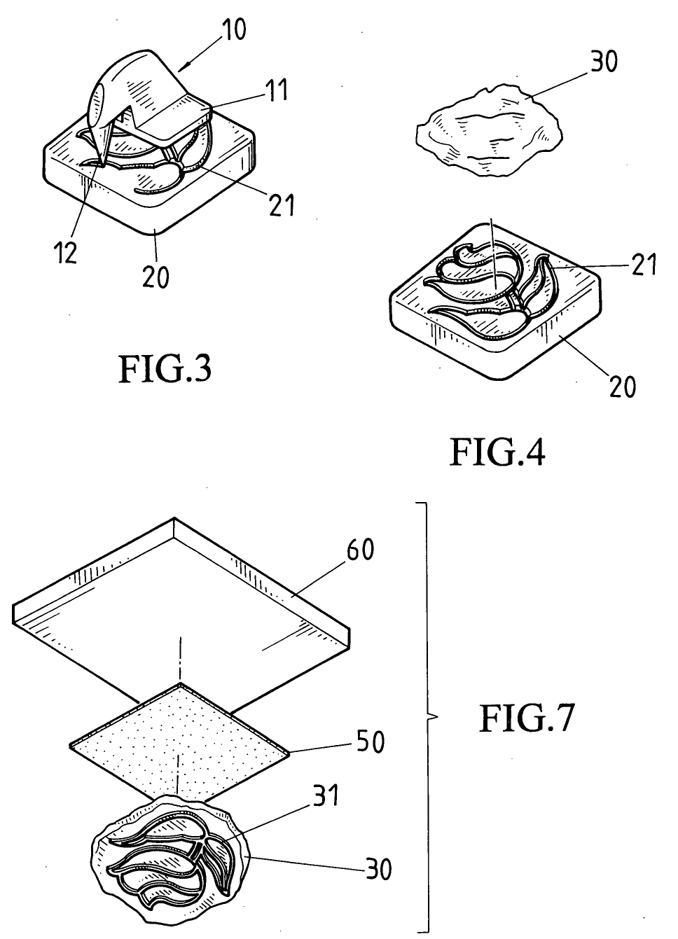

Step 1: Referring to FIG. 3, the horizontal seat 11 of the graving tool 10 is emplaced flat on a smooth surface of a bar of soap 20, and the protruded pointed cone 12 is pressed into the soap bar 20, such that a consumer can engrave on the soap bar 20, into notches 21 of texts or a pattern in equal depth, according to his or her preference, by snapping, pressing, pushing, and pulling.

Step 2: Referring to FIG. 4, flexible polymer clay 30 is rubbed and squeezed into a block in irregular-shape by fingers.

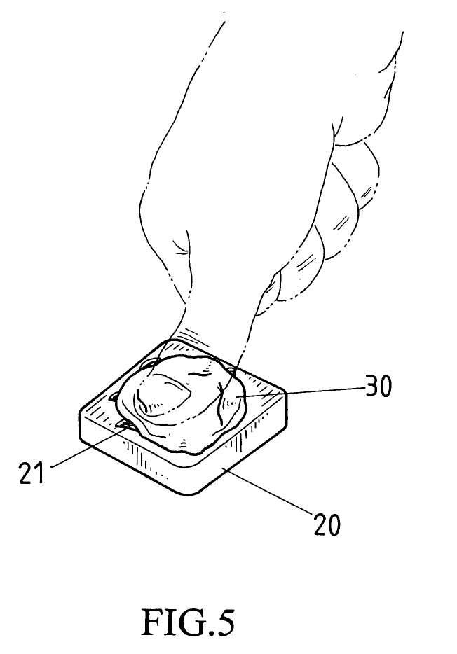

Step 3: Referring to FIG. 5, the flexible polymer clap 30 is pressed on the notches 21 of the soap bar 20 by a thumb, and a flat board can be put on a top of the flexible polymer clap 30 to help flattening.

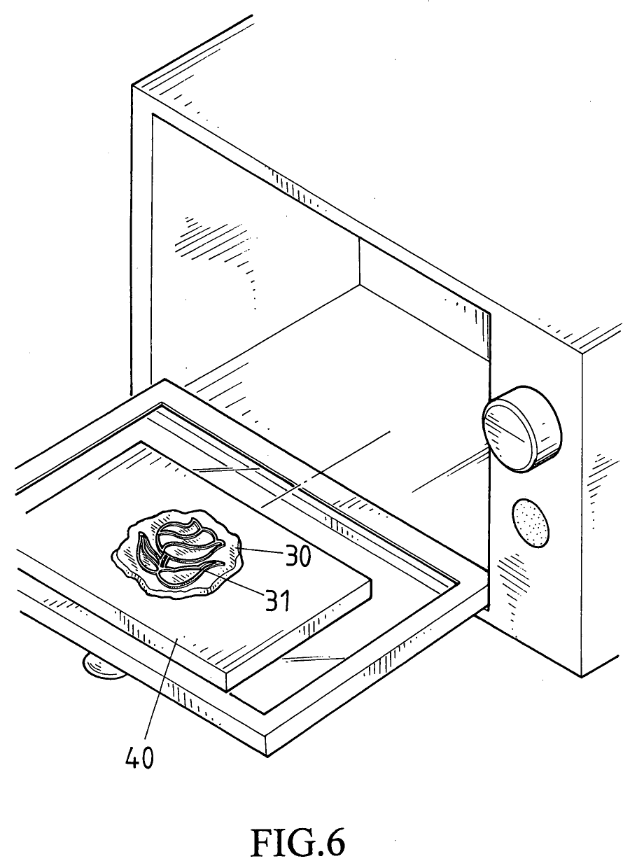

Step 4: Referring to FIG. 6, the pattern on the notches 21 of the soap bar 20 is copied on the flexible polymer clay 30 to form a protruded pattern 31, and then the flexible polymer clay 30 is gently taken out of the soap bar 20, followed by emplacing flat on a wood plate 40 and putting into an ordinary household oven for which temperature and time can be configured, to cure into a flexible rubber stamp, after baking for 20 minutes at temperature of 120° C.

Step 5: Referring to FIG. 7, a side of the baked flexible polymer clay 30 is attached to a double-sided adhesive tape 50 after cutting, and the other side of the double-sided adhesive tape 50 can be attached to an object 60. The object 60 can be an acryl plate, a wood block, or any block object in a cubical shape.

Accordingly, by using the present invention, a rubber stamp can be made by oneself according to one's preference, with a simple and easy-to-learn manufacturing process.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A device for making a rubber stamp by oneself comprising a graving tool, which is provided with a horizontal seat and a pointed cone, protruding vertically downward to exceed a bottom surface of the horizontal seat; a soap bar, a surface of which is engraved into notches of texts or a pattern, by the graving tool; flexible polymer clap, which is rubbed and squeezed and then pressed into the soap bar, to copy into a protruded pattern; a double-sided adhesive tape, a side of which is attached to the flexible polymer clay after baking and curing, and the other side of which is attached to an object.

2. The device for making a rubber stamp by oneself according to claim 1, wherein the graving tool is a product made by plastic extrusion.
